(19) United States
(12) Patent Application Publication
(10) Pub. No.: US 2013/0010710 A1
(43) Pub. Date: Jan. 10, 2013

(54) METHODS, USER EQUIPMENTS AND RADIO NETWORK CONTROLLERS IN A WIRELESS NETWORK FOR CONTROLLING DOWNLINK COMMUNICATION

(75) Inventors: Namir Lidian, Solna (SE); Paulson Angelo Vijay Silveris, Spanga (SE)

(73) Assignee: TELEFONAKTIEBOLAGET L M ERICSSON (publ), Stockholm (SE)

(21) Appl. No.: 13/501,031

(22) PCT Filed: Mar. 26, 2012
(86) PCT No.: PCT/SE12/50330

§ 371 Date: Sep. 17, 2012

Related U.S. Application Data
(60) Provisional application No. 61/473,948, filed on Apr. 11, 2011.

(51) Int. Cl. H04W 72/04

(52) U.S. Cl. 370/329

(57) ABSTRACT

The present disclosure relates to a method in a user equipment (100), configured for operation using a non-contiguous downlink carrier configuration within a first frequency band. Said non-contiguous downlink carrier configuration comprises at least two blocks wherein each block comprises one downlink carrier or several adjacent downlink carriers within the first frequency band and there is a gap between any two blocks among said at least two blocks. The method comprises receiving (502) a control signal indicating that compressed mode should be configured for a first block among said at least two blocks and that compressed mode should not be configured for a second block among said at least two blocks, and configuring (504) downlink compressed mode operation in the user equipment for the first block but not the second block in accordance with said received control signal. The disclosure also relates to a corresponding method in a radio network controller communicating with the user equipment.

### TECHNICAL FIELD

The present disclosure relates generally to methods, user equipments and radio network controllers in a wireless network for controlling the usage of compressed mode in downlink communication.

### BACKGROUND

Cellular communication networks evolve towards higher data rates, together with improved capacity and coverage. In the 3^{rd} Generation Partnership Project (3GPP) standardization body, technologies like Global System for Mobile Communication (GSM), General Packet Radio Service (GPRS), Wideband Code Division Multiple Access (WCDMA), High Speed Packet Access (HSPA) and Long Term Evolution (LTE) have been and are currently being developed.

In HSPA Rel-10, 3GPP has introduced four carrier High-Speed Downlink Packet Access (4C-HSDPA) operation which provides peak downlink data rates of 168 Mbps. Four configured downlink carriers can be spread across at most two frequency bands. Universal Terrestrial Radio Access Network/Frequency Division Duplex (UTRAN/FDD) frequency bands are listed in “3GPP TS 25.104 Base Station (BS) radio transmission and reception (FDD), version 10.1.0”. All configured downlink carriers within a frequency band need to be adjacent in 4C-HSDPA operation. Further, 3GPP provides support for eight carrier HSDPA (8C-HSDPA) in Rel-11. This will allow peak data rates up to 336 Mbps. As in Rel-10 the eight downlink carriers can be spread across two frequency bands and all configured carriers within a band need be adjacent.

For enabling a user equipment (UE) to perform measurements on inter frequencies, i.e. frequencies that differ from the frequencies to which the UE is tuned for receiving downlink (DL) transmissions, for e.g. performing handover, DL data may be transmitted in a compressed mode. In the DL compressed mode, idle DL periods are created in radio frames, i.e. periods in which no transmission of data occurs. In these idle periods, the UE may perform measurements on inter frequencies without losing any DL data transmitted to the UE. The measurements on inter frequencies may relate to measurements on frequencies allocated for use by the same radio access technology or measurements on frequencies allocated for use by another radio access technology such as e.g. GSM (the latter referred to as inter-RAT measurements). The terms “measurements on inter frequencies” and “inter frequency measurements” are used interchangeably throughout this disclosure.

When enabling the compressed mode with e.g. a Spread Factor 2 (SF2) or a Higher Layer Scheduling (HLS) method in the UE for inter frequency measurements during multi-cell operation in Rel-8, all the active DL carriers had to be configured with silent periods in DL data transmissions. Since no data transmission in DL occurs during the silent periods, there may be performance degradation in the downlink throughput to a tune of 50%.

To realize Dual Band HSDPA operation, i.e. that the DL carrier frequencies in e.g. 4C-HSDPA and 8C-HSDPA may be spread across two frequency bands, the UE is required to support two receivers: A first receiver that is receiving at the first frequency band and a second receiver that is receiving at the second frequency band. Based on this, in Rel-10, a capability was introduced to enable compressed mode selectively for each frequency band. Thereby, compressed mode may be used for only the first frequency band, to perform inter frequency measurements, while the second frequency band may be used for transmitting data even in the silent periods of the first frequency band. As a result, downlink throughput may be increased.

Although, there is still a need to improve downlink throughput in an HSPA system.

### SUMMARY

An object of the present invention is to address at least some of the problems and issues outlined above.

According to one aspect, a method is provided in a user equipment, UE, configured for operation using a non-contiguous downlink carrier configuration within a first frequency band, wherein said non-contiguous downlink carrier configuration comprises at least two blocks wherein each block comprises one downlink carrier or several adjacent downlink carriers within the first frequency band and there is a gap between any two blocks among said at least two blocks. The method comprises receiving a control signal indicating that compressed mode should be configured for a first block among said at least two blocks and that compressed mode should not be configured for a second block among said at least two blocks, and configuring downlink compressed mode operation in the UE for the first block but not the second block in accordance with said received control signal.

By applying compressed mode for a first block and not applying the compressed mode for a second block within the same frequency band DL data may be transmitted on the second block without interruptions due to compressed mode. Consequently, this idea may further improve downlink data throughput.

The terms carrier/carrier frequency, block/frequency block and gap/frequency gap are used in an interchangeable manner throughout this disclosure.

A frequency band is a frequency range in which E-UTRA, UTRA or GSM operates, either paired or unpaired, and that is typically defined with a specific set of technical requirements. UTRA/FDD frequencies are listed in 3GPP TS 25.104, version 10.0.0, see e.g. chapter 5.2, table 5.0.

A block, or frequency block, is an aggregation of adjacent frequencies within a frequency band.

According to a second aspect, a method is provided in a radio network controller for configuring compressed mode operation of a user equipment, wherein said user equipment is configured for operation using a non-contiguous downlink carrier configuration within a first frequency band. Said non-contiguous carrier configuration comprises at least two blocks wherein each block comprises one carrier or several adjacent downlink carriers within the first frequency band and there is a gap between any two blocks among said at least two blocks. The method comprises transmitting a control signal to the user equipment indicating that compressed mode should be configured for a first block among said at least two blocks and that compressed mode should not be configured for a second block among said at least two blocks.

According to a third aspect, a user equipment is provided that is configurable for operation using a non-contiguous downlink carrier configuration within a first frequency band. Said non-contiguous downlink carrier configuration comprises at least two blocks wherein each block comprises one downlink carrier or several adjacent downlink carriers within the first frequency band and there is a gap between any two blocks among said at least two blocks. The user equipment comprises a receiving means (e.g. a receiver) for receiving a control signal indicating that compressed mode should be configured for a first block among said at least two blocks and that compressed mode should not be configured for a second block among said at least two blocks, and a configuring means (e.g. a processor) for configuring downlink compressed mode operation in the user equipment for the first block but not the second block in accordance with said received control signal.

According to a fourth aspect, a Radio Network Controller is provided for configuring compressed mode operation of a user equipment, wherein said user equipment is configured for operation using a non-contiguous downlink carrier configuration within a first frequency band. Said non-contiguous downlink carrier configuration comprises at least two blocks wherein each block comprises one carrier or several adjacent downlink carriers within the first frequency band and there is a gap between any two blocks among said at least two blocks. The radio network controller comprises a transmitting means (e.g. a transmitter) for transmitting a control signal to the user equipment indicating that compressed mode should be configured for a first block among said at least two blocks and that compressed mode should not be configured for a second block among said at least two blocks.

The above methods, user equipments and radio network controllers may be configured and implemented according to different optional embodiments. Further possible features and benefits of this solution will become apparent from the detailed description below.

### BRIEF DESCRIPTION OF DRAWINGS

The invention is now described, by way of example, with reference to the accompanying drawings, in which:

FIG. 1 is a table illustrating a user equipment configuration based on a prior art method.

FIG. 2 is another table illustrating a user equipment configuration according to some possible embodiments.

FIG. 3 is a carrier frequency scenario for a UE.

FIG. 4 is a signaling diagram illustrating a method according to possible embodiments.

FIG. 5 is a signaling diagram illustrating a method according to further possible embodiments.

FIG. 6 is a flow chart illustrating a method in a user equipment according to a further possible embodiments.

FIG. 7 is a flow chart illustrating a method in a radio network controller according to further possible embodiments.

FIG. 8 is a flow chart illustrating a method in a radio base station according to further possible embodiments.

FIG. 9 is a schematic block diagram illustrating a user equipment, a radio base station and a radio network controller according to further possible embodiments.

### DETAILED DESCRIPTION

Briefly described, this disclosure is directed to improving downlink data throughput in a wireless communication system, especially in a HSPA system. This may be achieved by enabling compressed mode per block within a frequency band. Thereby, it is possible to transmit DL data without interruptions, i.e. without silent periods, on one block in a frequency band while another block is in compressed mode, enabling the receiver normally receiving data on this latter block to e.g. perform inter frequency measurements at silent periods. Consequently, the total amount of data that can be transmitted within a frequency band can be increased compared to conventional procedures.

As mentioned in the background section, in Rel-10 the 4C-HSPDA operation requires the DL carriers to be adjacent within each frequency band. There is a new Work Item (WI) in 3GPP to support implementation of non-adjacent downlink carriers as some of the operators do not have frequencies allocated contiguously, which prevent them from utilizing the full potential of 4C-HSDPA operation in UTRAN. By non-adjacent DL carriers is meant DL carriers that are not positioned adjacent to each other in the frequency domain.

To realize non-adjacent DL carriers in single band, the UE typically supports two receivers. Although, selective application of compressed mode is only enabled per frequency band. This means that the compressed mode is applied to all the downlink carrier frequencies for 4C-HSDPA operation in single band, also when the UE uses two receivers.

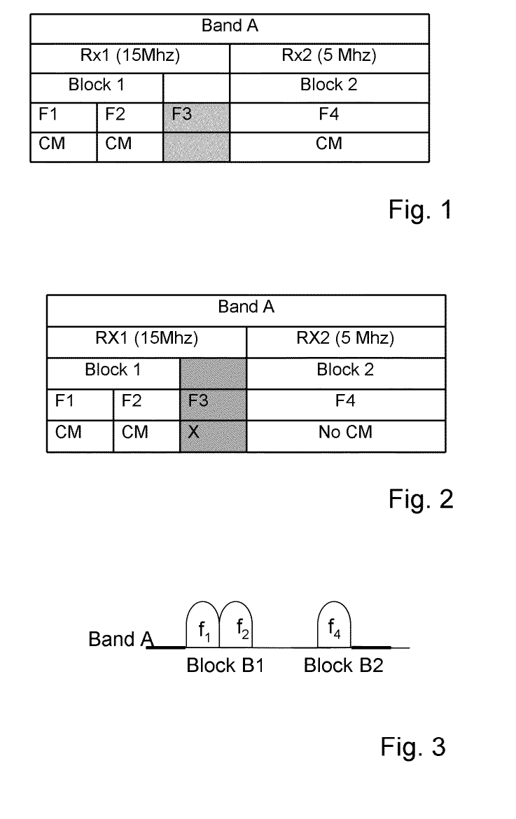

In FIG. 1, a typical prior art non-adjacent 4C-HSDPA deployment of carrier frequencies F1-F4 for DL transmission is shown. Adjacent frequencies F1 and F2 are configured (allocated to the UE), and so is also frequency F4 but not the intermediate frequency F3. Consequently, F3 separates the frequencies used for DL transmission to the UE by creating a gap between block 1 comprising F1, F2 and block 2 comprising F4, resulting in the non-adjacent frequency aggregation. As can be seen, according to the current specification, all frequencies are set in compressed mode (CM in FIG. 1), when inter frequency measurements are performed resulting in low DL data throughput.

However, by applying embodiments of the invention instead of the above conventional procedure, compressed mode can be applied per block. Thereby, as shown in FIG. 2, if the UE needs to measure on frequency F3 for example, block 1, comprising frequencies F1 and F2, may be set in compressed mode (CM in FIG. 1), whereas block 2, comprising frequency F4, is set in non-compressed mode (No CM in FIG. 2), which means that data may be transmitted with full rate on frequency F4. Consequently, the total data throughput has increased as compared to FIG. 1, where all frequencies F1, F2, F4 have to be set in compressed mode for performing inter frequency measurements on frequency F3.

According to embodiments of the invention, for a UE that supports non-contiguous carrier configurations within a single band, the compressed mode can be applied per block, where each block comprises one or more adjacent carriers within one band. The one or more carriers within a block are contiguous and there is a gap between any two “Blocks”. A gap may be one or more non-configured frequency carrier(s). If the band of the frequency to measure (inter-frequency measurement) belongs to one of two bands (such as band A) and the compressed mode is required, then the compressed mode could be applied per “Block” instead of per band. This way the data reception on the other blocks belonging to the same band A will not be unnecessarily affected. For example if a UE is configured with two blocks, Block B1 and Block B2 within one band, band A, as illustrated in FIG. 3, and Block B1 consists of two adjacent carriers f1 and f2 and Block B2 consists of one carrier f4 then by applying the compressed mode only to Block B1, data reception on Block B2 will not be interrupted, and consequently the overall throughput would be improved. Thereby, to perform an inter-frequency measurement on a frequency outside f1, f2 or f4, only one of the Blocks, e.g. Block B1, has to be put in compressed mode whereas data on the other block, e.g. Block B2 can be transmitted without interruptions. To measure an inter frequency f4, it is not necessary to configure the compressed mode for the downlink carrier f4, of FIG. 3.

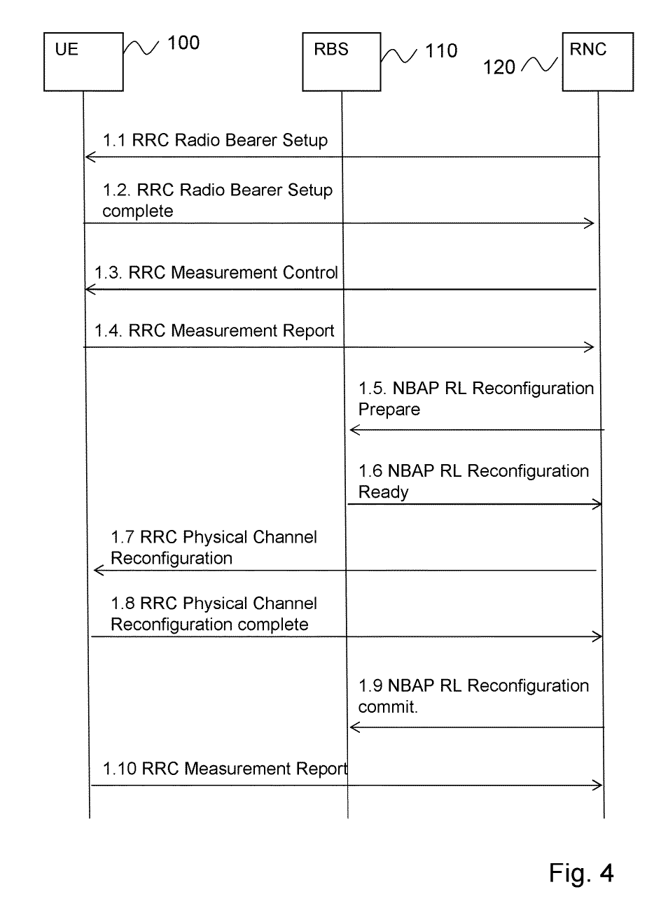

An example scenario illustrating some embodiments is shown in FIG. 4. In this example scenario, configuration of compressed mode in a non-adjacent 4C-HSDPA carrier configuration is discussed.

In steps 1.1 to 1.2 in FIG. 4, an RNC 120 configures a UE 100 with a HSPA Radio Access Bearer (RAB) with non-adjacent 4C-HSDPA configuration. The UE, which in this example scenario includes two receivers, is configured with two blocks and a gap between the two blocks in the downlink. The activated downlink frequencies are f1, f2 and f4. In step 1.3 the RNC 120 sends an RRC measurement Control message to a UE 100 to start the measurements.

In step 1.4, the UE 100 reports event 2d, (the estimated quality of the currently used frequency is below a certain threshold) in a RRC Measurement Report message to the RNC 120. In other example scenarios, the UE could report other events, such as e.g. event 6d. Events 2d and 6d are defined in 3GPP TS 25.331.

Upon receipt of the RRC Measurement Report message, the RNC 120 analyses the inter-frequency neighbor cells of the UEs current active set and the RNC identifies the list of inter-frequencies to measure and checks if the frequency to measure is already configured for the downlink carriers. From this result, the RNC decides which block should be configured with compressed mode and which block should not be configured with compressed mode.

In step 1.5, the RNC 120 sends a NBAP RI Reconfiguration Prepare message to a Radio Base Station (RBS) 110 engaged in downlink data transmission to the UE 100 utilizing the non-adjacent 4C-HSDPA configuration. The message indicates to the RBS 110 for which blocks compressed mode should be configured and for which blocks compressed mode should not be configured. The message may indicate the compressed mode setting per downlink carrier by including an optional “Transmission Gap Pattern Sequence Information (TGPS)” information element (e.g. as part of the “Additional HS Cell Information RL Reconf Prep” information element) for downlink carriers where compressed mode should be configured. Hence if the TGPS information element is present for a carrier, compressed mode should be configured for the carrier and otherwise compressed mode should not be configured for the carrier.

In step 1.6, the RBS 110 returns a NBAP RL Reconfiguration Ready message to the RNC 120 as an indication of the successful reconfiguration preparation.

In step 1.7, the RNC 120 sends a RRC Physical Channel Reconfiguration message to the UE 100 indicating for which block compressed mode should be configured and for which block compressed mode should not be configured. As one alternative, a DPCH-CompressedModeInfo information element, included in the RRC Physical Channel Reconfiguration message can be modified to include the carrier frequencies for which a Transmission Gap Pattern Sequence (TGPS) should not be applied, i.e. the carrier frequencies for which compressed mode should not be configured.

As another alternative, a “Downlink Secondary Cell Info FDD” information element included in the RRC Physical Channel Reconfiguration message can be modified to include an optional flag indicating configuration of compressed mode. Hence presence of this flag in the “Downlink Secondary Cell Info FDD” information element associated with a downlink carrier indicates to the UE that compressed mode should be configured for this carrier while absence of this flag indicates that no compressed mode should be configured for the downlink carrier.

The UE 100 configures downlink compressed mode operation in the UE in accordance with the RRC Physical Channel Reconfiguration message received from the RNC 120 and returns 1.8 a RRC Physical Channel Reconfiguration Complete message to the RNC.

In step 1.9, the RNC 120 sends an NBAP RL Reconfiguration commit signal to the RBS 110 ordering the RBS to apply the configuration sent in step 1.5.

In step 1.10, the UE 100 reports event 2b (the estimated quality of the currently used frequency is below a certain threshold and the estimated quality of a non-used frequency is above a certain threshold). Event 2b is defined in 3GPP TS 25.331.

Even though the exemplary embodiments disclosed above are described in the context of 4C-HSDPA operation (4 carriers), the invention is not limited to 4C-HSDPA operation but can also be applied in the context of e.g. 8C-HSDPA operation (8 carriers).

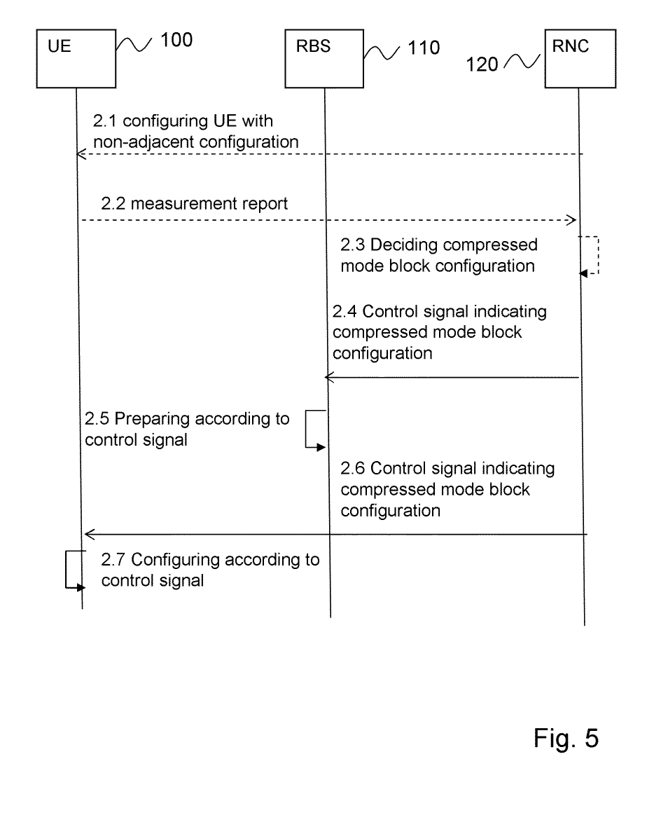

FIG. 5 shows a communication scenario according to possible embodiments. The communication scenario may start by the RNC 120 sending 2.1 a message for configuring the UE 100 with a non-adjacent configuration in the DL, i.e. with two blocks with a gap in between the blocks. Further, the UE 100 may send 2.2 a measurement report to the RNC informing that signal quality on a currently used DL channel is below a certain level. Then the RNC identifies which inter-frequencies that need to be measured and compares the identified inter-frequencies with the already configured frequencies for the UE. From this comparison, the RNC may decide 2.3 which block should be configured with compressed mode and which block should not be configured with compressed mode. Thereafter, the RNC may send 2.4 a control signal indicating the decided compressed mode block configuration to the RBS 110 handling DL transmission to the UE 100. The RBS 110 then prepares 2.5 its receivers and transmitters for DL communication according to the decided compressed mode configuration of the control signal. Also, the RNC 120 may send a 2.6 a control signal indicating the decided compressed mode block configuration to the UE. The UE 100 then configures 2.7 its receivers for DL communication according to the decided compressed mode configuration of the control signal. Thereafter, the RNC may send a signal to the RBS to activate compressed mode at the RBS. Further, the RNC may send a signal to the UE to activate compressed mode at the UE. Alternatively, the RBS may be triggered to perform the steps of preparing and activating based on only one control signal from the RNC. Also, the UE may be triggered to perform the steps of configuring and activating based on only one control signal from the RNC

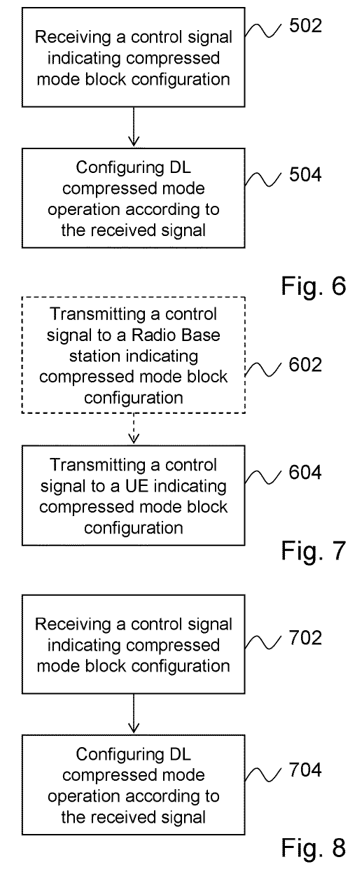

FIG. 6 shows a method in a UE 100, configured for operation using a non-contiguous downlink carrier configuration within a first frequency band, wherein said non-contiguous downlink carrier configuration comprises at least two blocks wherein each block comprises one downlink carrier or several adjacent downlink carriers within the first frequency band and there is a gap between any two blocks among said at least two blocks. The method comprises receiving 502 a control signal indicating that compressed mode should be configured for a first block among said at least two blocks and that compressed mode should not be configured for a second block among said at least two blocks, and configuring 504 downlink compressed mode operation in the UE for the first block but not the second block in accordance with said received control signal.

According to an embodiment, the control signal is a Radio Resource Control message.

According to yet another embodiment, the Radio Resource Control message includes a DPCH-CompressedModeInfo information element including carrier frequencies for which a Transmission Gap Pattern Sequence should not be applied.

According to another embodiment, the UE 100 determines that compressed mode should not be configured for the second block based on the second block including a downlink carrier whose frequency is included among the carrier frequencies for which the Transmission Gap Pattern Sequence should not be applied.

According to still another embodiment, the UE 100 determines that compressed mode should be configured for the first block based on the first block not including any downlink carrier with a frequency included among the carrier frequencies for which the Transmission Gap Pattern Sequence should not be applied.

According to another embodiment, for each carrier in the first block, the Radio Resource Control message includes a flag indicating that compressed mode should be configured for that carrier.

FIG. 7 shows a method in a Radio Network Controller, RNC, 120 for configuring compressed mode operation of a UE 100 wherein said UE is configured for operation using a non-contiguous downlink carrier configuration within a first frequency band, wherein said non-contiguous carrier configuration comprises at least two blocks wherein each block comprises one carrier or several adjacent downlink carriers within the first frequency band and there is a gap between any two blocks among said at least two blocks. The method comprises transmitting 604 a control signal to the UE 100 indicating that compressed mode should be configured for a first block among said at least two blocks and that compressed mode should not be configured for a second block among said at least two blocks. Thereby, the UE is instructed to configure compressed mode accordingly. As a result, compressed mode is enabled per block for DL communication between the RNC and UE, which enhances DL throughput.

According to an embodiment, the method in the RNC further comprises transmitting 602 a control signal to a Radio Base Station, RBS, 110 engaged in downlink data transmission to the UE 100 utilizing said non-contiguous downlink carrier configuration. Said control signal transmitted to the RBS indicates that compressed mode should be configured for the first block among said at least two blocks and that compressed mode should not be configured for the second block among said at least two blocks. Thereby, the RBS is instructed to configure compressed mode accordingly. As a result, compressed mode is enabled per block for DL communication, which enhances DL throughput.

According to an embodiment of the method in the RNC 120, the Radio Resource Control message indicates for each downlink carrier in the first block that compressed mode should be configured for that carrier and wherein the control signal indicates for each carrier in the second block that compressed mode should not be configured for that carrier.

According to another embodiment of the method in the RNC 120, the Radio Resource Control message includes a DPCH-CompressedModeInfo information element including carrier frequencies for which a Transmission Gap Pattern Sequence should not be applied.

According to another embodiment of the method in the RNC 120, for each carrier in the first block, the Radio Resource Control message includes a flag indicating that compressed mode should be configured for that carrier.

FIG. 8 shows a method in a radio base station, RBS, 110 configured for operation using a downlink carrier frequency configuration within a first frequency band. Said carrier frequency configuration comprises at least two frequency blocks wherein each frequency block comprises one downlink carrier frequency or several adjacent downlink carrier frequencies within the first frequency band and there is a frequency gap between any two frequency blocks among said at least two frequency blocks. The method comprises receiving 702 a control signal from a radio network controller 120 indicating that compressed mode should be configured for a first frequency block among said at least two frequency blocks and that compressed mode should not be configured for a second frequency block among said at least two frequency blocks, and configuring 704 downlink compressed mode operation in the radio base station 110 for the first frequency block but not the second frequency block in accordance with said received control signal.

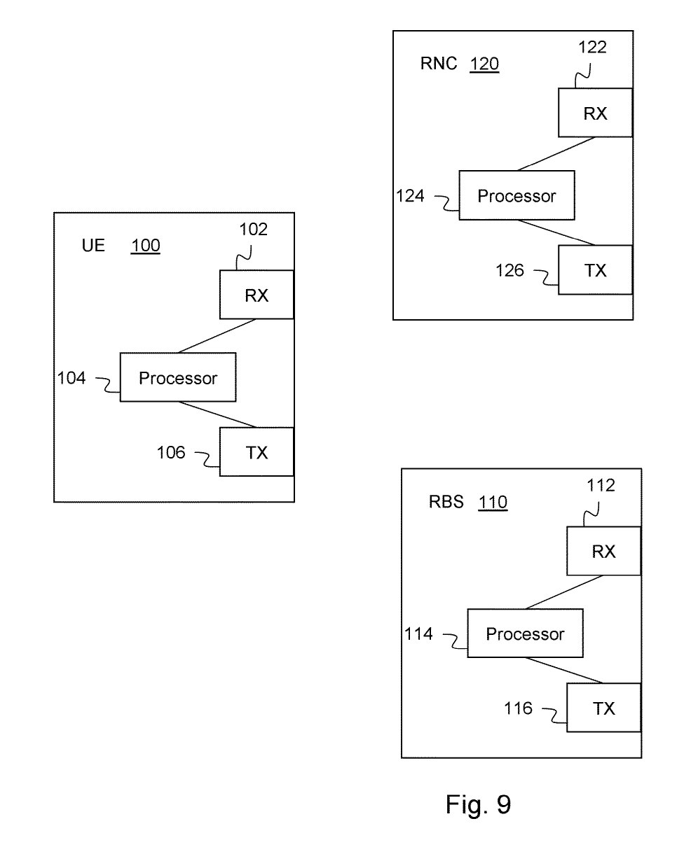

FIG. 9 describes a user equipment, UE, 100, a radio base station, RBS, 110 and a radio network controller, RNC, 120 arranged for communication in a radio access network.

The UE 100 may be configurable for operation using a non-contiguous downlink carrier configuration within a first frequency band, wherein said non-contiguous downlink carrier configuration comprises at least two blocks wherein each block comprises one downlink carrier or several adjacent downlink carriers within the first frequency band and there is a gap between any two blocks among said at least two blocks. The UE 100 comprises a receiving means 102 for receiving a control signal indicating that compressed mode should be configured for a first block among said at least two blocks and that compressed mode should not be configured for a second block among said at least two blocks, and a processor 104 for configuring downlink compressed mode operation in the UE for the first block but not the second block in accordance with said received control signal. The UE may also comprise a transmitting means 106 for transmitting data to the RNC and/or the RBS.

According to embodiments, the receiving means 102 may be any kind of receiving means such as a receiver, a receiver unit, a receiving part or portion of a transceiver etc. Further, the processor 104 is an example of a configuring means, other examples are a configuring unit, a configuring portion of the UE, or any kind of intelligence in the UE adapted for configuring downlink compressed mode operation in the UE.

According to an embodiment, the control signal that the receiving means is arranged to receive may be a Radio Resource Control message.

The Radio Resource Control message may indicate for each downlink carrier in the first block that compressed mode should be configured for that carrier and the control signal may indicate for each carrier in the second block that compressed mode should not be configured for that carrier.

The Radio Resource Control message may include a DPCH-CompressedModeInfo information element including carrier frequencies for which a Transmission Gap Pattern Sequence should not be applied.

Further, the UE 100 may be arranged to determine that compressed mode should not be configured for the second block based on the second block including a downlink carrier whose frequency is included among the carrier frequencies for which the Transmission Gap Pattern Sequence should not be applied.

Further, the UE may be arranged to determine that compressed mode should be configured for the first block based on the first block not including any downlink carrier with a frequency included among the carrier frequencies for which the Transmission Gap Pattern Sequence should not be applied.

The RBS 110 may be configured for operation using a downlink carrier frequency configuration within a first frequency band. The carrier frequency configuration comprises at least two frequency blocks wherein each frequency block comprises one downlink carrier frequency or several adjacent downlink carrier frequencies within the first frequency band and there is a frequency gap between any two frequency blocks among said at least two frequency blocks. The RBS 110 comprises a receiving means 112 for receiving a control signal from the RNC 110 indicating that compressed mode should be configured for a first frequency block among said at least two frequency blocks and that compressed mode should not be configured for a second frequency block among said at least two frequency blocks, and a processor 114 for configuring downlink compressed mode operation in the RBS for the first frequency block but not the second frequency block in accordance with said received control signal. A processor is a possible example of a configuring means. The RBS may also comprise a transmitting means 116 for transmitting data to the RNC 120 and/or the UE 100.

The RNC 120 may be arranged for configuring compressed mode operation of the UE 100, wherein said UE is configured for operation using a non-contiguous downlink carrier configuration within a first frequency band, and wherein said non-contiguous downlink carrier configuration comprises at least two blocks wherein each block comprises one carrier or several adjacent downlink carriers within the first frequency band and there is a gap between any two blocks among said at least two blocks. The RNC 120 comprises: a transmitting means 126 for transmitting a control signal to the UE 100 indicating that compressed mode should be configured for a first block among said at least two blocks and that compressed mode should not be configured for a second block among said at least two blocks.

According to an embodiment, the transmitting means 126 of the RNC 120 is further arranged for transmitting a control signal to the RBS 110 engaged in downlink data transmission to the UE 100 utilizing said non-contiguous downlink carrier configuration, wherein said control signal transmitted to the RBS indicates that compressed mode should be configured for the first block among said at least two blocks and that compressed mode should not be configured for the second block among said at least two blocks.

The control signal that the transmitting means 126 is arranged to transmit to the UE 100 may be a Radio Resource Control message. The Radio Resource Control message may indicate for each downlink carrier in the first block that compressed mode should be configured for that carrier and the control signal may indicate for each carrier in the second block that compressed mode should not be configured for that carrier.

The Radio Resource Control message may include a DPCH-CompressedModeInfo information element including carrier frequencies for which a Transmission Gap Pattern Sequence should not be applied. Further, for each carrier in the first block, the Radio Resource Control message may include a flag indicating that compressed mode should be configured for that carrier.

The RNC 120 may also comprise a receiving unit 122 for receiving data, such as measurement reports from the UE 100 or acknowledgement messages from the UE or the RBS. The RNC 120 may also comprise a processor 124 for e.g. deciding which blocks should be configured with compressed mode and which blocks should not be configured with compressed mode.

According to embodiments, the transmitting means 126 may be any kind of transmitting means such as a transmitter, a transmitter unit, a transmitting part or portion of a transceiver etc.

In FIG. 9, the receiving unit and the transmitting unit shown in the UE, RNC and RBS respectively, might as well any of them be replaced by a transceiving unit, which is a combined receiving unit and transmitting unit.

At least one of the embodiments described may achieve at least one of the following advantages: Since compressed mode is enabled per block within a frequency band, instead of for all frequencies within a frequency band as in prior art, an increased flexibility is achieved which results in improved throughput. In other words, compressed mode could be enabled for one block within a frequency band, whereas on another block within the same frequency band, data could be sent without interruptions. Consequently, the total amount of data sent over the frequency band is increased. Also, by applying compressed mode only to a certain block it is possible for the radio network to continue transmitting higher priority data on other blocks which are not in compressed mode.

Even though the invention is described in the context of DL signals, it might as well be used for uplink signals. In this case, a non-contiguous uplink carrier configuration is handled, and the UE is configured for uplink compressed mode operation for a first block but not a second block within a frequency band.

While the invention has been described with reference to specific exemplary embodiments, the description is generally only intended to illustrate the inventive concept and should not be taken as limiting the scope of the invention. The invention is defined by the appended claims.

1. A method in a user equipment, UE, configured for operation using a non-contiguous downlink carrier configuration within a first frequency band, wherein said non-contiguous downlink carrier configuration comprises at least two blocks wherein each block comprises one downlink carrier or several adjacent downlink carriers within the first frequency band and there is a gap between any two blocks among said at least two blocks, the method comprising:
receiving a control signal indicating that compressed mode should be configured for a first block among said at least two blocks and that compressed mode should not be configured for a second block among said at least two blocks; and
configuring downlink compressed mode operation in the UE for the first block but not the second block in accordance with said received control signal.

2. Method according to claim 1, wherein the control signal is a Radio Resource Control message.

3. Method according to claim 2, wherein the Radio Resource Control message indicates for each downlink carrier in the first block that compressed mode should be configured for that carrier and wherein the control signal indicates for each carrier in the second block that compressed mode should not be configured for that carrier.

4. Method according to claim 2, wherein said Radio Resource Control message includes a DPCH-CompressedModeInfo information element including carrier frequencies for which a Transmission Gap Pattern Sequence should not be applied.

5. Method according to claim 4, wherein the UE determines that compressed mode should not be configured for the second block based on the second block including a downlink carrier whose frequency is included among the carrier frequencies for which the Transmission Gap Pattern Sequence should not be applied.

6. Method according to claim 4 or 5, wherein the UE determines that compressed mode should be configured for the first block based on the first block not including any downlink carrier with a frequency included among the carrier frequencies for which the Transmission Gap Pattern Sequence should not be applied.

7. Method according to claim 3, wherein for each carrier in the first block, the Radio Resource Control message includes a flag indicating that compressed mode should be configured for that carrier.

8. A method in a Radio Network Controller for configuring compressed mode operation of a user equipment, UE, wherein said UE is configured for operation using a non-contiguous downlink carrier configuration within a first frequency band, wherein said non-contiguous carrier configuration comprises at least two blocks wherein each block comprises one carrier or several adjacent downlink carriers within the first frequency band and there is a gap between any two blocks among said at least two blocks, the method comprising:
transmitting a control signal to the UE indicating that compressed mode should be configured for a first block among said at least two blocks and that compressed mode should not be configured for a second block among said at least two blocks.

9. Method according to claim 8, wherein the method further comprises:
transmitting a control signal to a Radio Base Station engaged in downlink data transmission to the UE utilizing said non-contiguous downlink carrier configuration, wherein said control signal transmitted to the Radio Base Station indicates that compressed mode should be configured for the first block among said at least two blocks and that compressed mode should not be configured for the second block among said at least two blocks.

10. Method according to claim 8, wherein the control signal transmitted to the UE is a Radio Resource Control message.

11. Method according to claim 10, wherein the Radio Resource Control message indicates for each downlink carrier in the first block that compressed mode should be configured for that carrier and wherein the control signal indicates for each carrier in the second block that compressed mode should not be configured for that carrier.

12. Method according to claim 10, wherein said Radio Resource Control message includes a DPCH-CompressedModeInfo information element including carrier frequencies for which a Transmission Gap Pattern Sequence should not be applied.

13. Method according to claim 11, wherein for each carrier in the first block, the Radio Resource Control message includes a flag indicating that compressed mode should be configured for that carrier.

14. A user equipment, UE, configurable for operation using a non-contiguous downlink carrier configuration within a first frequency band, wherein said non-contiguous downlink carrier configuration comprises at least two blocks wherein each block comprises one downlink carrier or several adjacent downlink carriers within the first frequency band and there is a gap between any two blocks among said at least two blocks, the user equipment comprising:
a receiving means for receiving a control signal indicating that compressed mode should be configured for a first block among said at least two blocks and that compressed mode should not be configured for a second block among said at least two blocks;
a configuring means for configuring downlink compressed mode operation in the UE for the first block but not the second block in accordance with said received control signal.

15. User equipment according to claim 14, wherein the control signal is a Radio Resource Control message.

16. User equipment according to claim 15, wherein the Radio Resource Control message indicates for each downlink carrier in the first block that compressed mode should be configured for that carrier and wherein the control signal indicates for each carrier in the second block that compressed mode should not be configured for that carrier.

17. User equipment according to claim 15, wherein said Radio Resource Control message includes a DPCH-CompressedModeInfo information element including carrier frequencies for which a Transmission Gap Pattern Sequence should not be applied.

18. User equipment according to claim 17, wherein the UE is arranged to determine that compressed mode should not be configured for the second block based on the second block including a downlink carrier whose frequency is included among the carrier frequencies for which the Transmission Gap Pattern Sequence should not be applied.

19. User equipment according to claim 17, wherein the UE is arranged to determine that compressed mode should be configured for the first block based on the first block not including any downlink carrier with a frequency included among the carrier frequencies for which the Transmission Gap Pattern Sequence should not be applied.

20. User equipment according to claim 16, wherein for each carrier in the first block, the Radio Resource Control message includes a flag indicating that compressed mode should be configured for that carrier.

21. A user equipment, UE, configurable for operation using a non-contiguous downlink carrier configuration within a first frequency band, wherein said non-contiguous downlink carrier configuration comprises at least two blocks wherein each block comprises one downlink carrier or several adjacent downlink carriers within the first frequency band and there is a gap between any two blocks among said at least two blocks, the user equipment comprising:
a receiver for receiving a control signal indicating that compressed mode should be configured for a first block among said at least two blocks and that compressed mode should not be configured for a second block among said at least two blocks;
a processor for configuring downlink compressed mode operation in the UE for the first block but not the second block in accordance with said received control signal.

22. A Radio Network Controller for configuring compressed mode operation of a user equipment, UE, wherein said UE is configured for operation using a non-contiguous downlink carrier configuration within a first frequency band, wherein said non-contiguous downlink carrier configuration comprises at least two blocks wherein each block comprises one carrier or several adjacent downlink carriers within the first frequency band and there is a gap between any two blocks among said at least two blocks, the radio network controller comprising:
a transmitting means for transmitting a control signal to the UE indicating that compressed mode should be configured for a first block among said at least two blocks and that compressed mode should not be configured for a second block among said at least two blocks.

23. Radio Network Controller according to claim 22, wherein the transmitting means is further arranged for transmitting a control signal to a Radio Base Station engaged in downlink data transmission to the UE utilizing said non-contiguous downlink carrier configuration, wherein said control signal transmitted to the Radio Base Station indicates that compressed mode should be configured for the first block among said at least two blocks and that compressed mode should not be configured for the second block among said at least two blocks.

24. Radio Network Controller according to claim 22, wherein the control signal that the transmitting means is arranged to transmit to the UE is a Radio Resource Control message.

25. Radio Network Controller according to claim 24, wherein the Radio Resource Control message indicates for each downlink carrier in the first block that compressed mode should be configured for that carrier and wherein the control signal indicates for each carrier in the second block that compressed mode should not be configured for that carrier.

26. Radio Network Controller according to claim 24, wherein said Radio Resource Control message includes a DPCH-CompressedModeInfo information element including carrier frequencies for which a Transmission Gap Pattern Sequence should not be applied.

27. Radio Network Controller according to claim 25, wherein for each carrier in the first block, the Radio Resource Control message includes a flag indicating that compressed mode should be configured for that carrier.

28. A Radio Network Controller for configuring compressed mode operation of a user equipment, UE, wherein said UE is configured for operation using a non-contiguous downlink carrier configuration within a first frequency band, wherein said non-contiguous downlink carrier configuration comprises at least two blocks wherein each block comprises one carrier or several adjacent downlink carriers within the first frequency band and there is a gap between any two blocks among said at least two blocks, the radio network controller comprising:
a transmitter for transmitting a control signal to the UE indicating that compressed mode should be configured for a first block among said at least two blocks and that compressed mode should not be configured for a second block among said at least two blocks.
